(19) United States
(12) Patent Application Publication
(10) Pub. No.: US 2018/0236537 A1
(43) Pub. Date: Aug. 23, 2018

(54) RAW MATERIAL POWDER FOR SOFT MAGNETIC POWDER, AND SOFT MAGNETIC POWDER FOR DUST CORE

(71) Applicant: JFE STEEL CORPORATION, Chiyoda-ku/ Tokyo (JP)

(72) Inventors: Takuya TAKASHITA, Chiyoda-ku, Tokyo (JP); Akio KOBAYASHI, Chiyoda-ku, Tokyo (JP); Naomichi NAKAMURA, Chiyoda-ku, Tokyo (JP)

(73) Assignee: JFE STEEL CORPORATION, Chiyoda-ku, Tokyo (JP)

(21) Appl. No.: 15/548,850

(22) PCT Filed: Feb. 8, 2016
(86) PCT No.: PCT/JP2016/000641

§ 371 Date: Aug. 4, 2017

(30) Foreign Application Priority Data
Feb. 9, 2015 (JP) 2015-023399

(51) Int. Cl. B22F 1/02; B22F 3/00; C22C 38/02; H01F 1/20; B22F 1/00; H01F 3/08

(52) U.S. Cl. CPC B22F 1/02; B22F 3/006; H01F 3/08; H01F 1/20; B22F 1/0059; C22C 38/02

(57) ABSTRACT

Soft magnetic powder for dust cores that yields dust cores having low eddy current loss is provided. Raw material powder for soft magnetic powder comprises Fe: 60 mass % or more, a γ-phase stabilizing element, and an electric resistance-increasing element: 1.0 mass % or more.

### TECHNICAL FIELD

The disclosure relates to soft magnetic powder for dust cores having low eddy current loss and having excellent magnetic properties in high-frequency applications, and raw material powder for yielding the soft magnetic powder.

### BACKGROUND

Dust cores obtained by pressure forming powder for dust cores are used in, for example, stator cores or rotor cores of drive motors of vehicles, reactor cores in power converter circuits, etc. Dust cores have many advantages such as magnetic properties with low high-frequency iron loss, capability of coping with various shapes flexibly and inexpensively, and low material cost, as compared with core material obtained by stacking electrical steel sheets.

In recent years, higher frequencies have been increasingly used in the aforementioned applications such as motors and reactors, and dust cores have been increasingly required to have lower high-frequency iron loss. The iron loss of an iron core is divided into hysteresis loss and eddy current loss. At higher frequencies, the ratio of eddy current loss in iron loss is particularly high. Hence, reducing eddy current loss is especially important for a reduction in high-frequency iron loss. This has stimulated various efforts of reducing eddy current loss in dust cores.

The eddy current loss of a dust core is further divided into intra-particle eddy current loss due to eddy current flowing inside individual particles and inter-particle eddy current loss due to eddy current flowing between particles.

A known method of reducing inter-particle eddy current loss due to eddy current flowing between particles is to apply an insulating coating to the particle surface. For example, a coating using phosphate as described in JP 2010-511791 A (PTL 1), a coating using silicone resin as described in JP 2013-187480 A (PTL 2), and a coating using phosphate and silicone resin in combination as described in JP 2008-63651 A (PTL 3) are proposed as such insulating coatings. Various techniques for reducing inter-particle eddy current loss are thus proposed, and inter-particle eddy current loss can be reduced sufficiently.

On the other hand, there seems to be still no adequate technique for reducing intra-particle eddy current loss.

For example, Denki-Seiko (Electric Furnace Steel), Daido Steel Co., Ltd., 2011, Vol. 82, No. 1, p. 57-65 (NPL 1) describes adding Si to iron particles for high alloying, to increase electric resistance in the particles and reduce eddy current loss.

JP 2008-297606 A (PTL 4) and JP H11-87123 A (PTL 5) disclose techniques of reducing eddy current loss by concentrating Si in the surface layer of pure iron powder by a CVD method using SiCl₄. These techniques are intended to reduce intra-particle eddy current loss, by concentrating Si in the powder surface layer so that magnetic flux concentrates in the powder surface layer.

JP 2011-146604 A (PTL 6) discloses a technique of obtaining a dust core with high electric resistance and low eddy current loss, by causing fine particles of SiO₂ retained in a process of concentrating Si in the surface layer of soft magnetic powder to diffusionally adhere to the surface of the soft magnetic powder.

This technique combines intra-particle eddy current loss reduction using the concentration of magnetic flux in the powder surface layer by the concentration of Si in the surface layer and inter-particle eddy current loss reduction using retained SiO₂.

### CITATION LIST

### Patent Literatures

PTL 1: JP 2010-511791 A
PTL 2: JP 2013-187480 A
PTL 3: JP 2008-63651 A
PTL 4: JP 2008-297606 A
PTL 5: JP H11-87123 A
PTL 6: JP 2011-146604 A

### Non-Patent Literatures

NPL 1: Denki-Seiko (Electric Furnace Steel), Daido Steel Co., Ltd., 2011, Vol. 82, No. 1, p. 57-65

### SUMMARY

### Technical Problem

However, the addition of a large amount of Si described in NPL 1 causes lower saturation magnetization of the material, and lower compressibility during forming due to the hardening of the powder. Lower compressibility leads to lower green density and, consequently, lower saturation magnetization of a magnetic core.

To use powder for actual material, the saturation magnetization of a magnetic core formed using the powder needs to be 1.8 T or more. To achieve this, the saturation magnetic moment of the soft magnetic powder as raw material needs to be 180 emu/g or more. Due to these constraints, eddy current loss reduction by the addition of Si to Fe is currently limited only to effects achieved by adding about 3 mass % Si.

The techniques described in PTL 4 and PTL 5 are techniques of concentrating Si in pure iron powder. However, since the electric resistance of the pure iron powder as base material is not as high as that of an Fe—Si alloy, eddy current loss cannot be sufficiently reduced even when Si is concentrated in the surface layer. Besides, in the case of performing Si concentration in the surface layer of Fe—Si alloy powder using the techniques described in PTL 4 and PTL 5, Si diffuses very fast because the α phase is stabilized in the siliconizing temperature range by Si contained in the powder. This makes it extremely difficult to accurately concentrate Si in the surface layer.

With the technique described in PTL 6, Si diffuses very fast because the α phase is stabilized in the siliconizing temperature range when adding Si to base powder, and so Si concentration in the surface layer is extremely difficult, as with PTL 4 and the like.

Thus, the conventional techniques all have difficulty in meeting the growing need for eddy current loss reduction.

It could be helpful to provide soft magnetic powder for dust cores that yields dust cores with low eddy current loss, and raw material powder for the soft magnetic powder.

### Solution to Problem

Upon carefully examining eddy current loss in dust cores, we discovered the following:

(i) The diffusion of Si in soft magnetic powder differs significantly between in the case where iron in the matrix phase is in the α phase and in the case where iron in the matrix phase is in the γ phase. The diffusion speed of Si in the γ phase is much lower than the diffusion speed of Si in the α phase.

(ii) By adjusting the composition of the base powder so that the γ phase is stable when performing heat treatment for concentrating Si in the particle surface layer, higher concentration of Si in the particle surface layer than in the particle center part is possible even though the base powder contains Si.

(iii) By increasing the amount of Si in the particle center part, eddy current loss when concentrating Si in the particle surface layer can be reduced effectively.

The disclosure is based on these discoveries.

We thus provide:

1. Raw material powder for soft magnetic powder, comprising Fe: 60 mass % or more, a γ-phase stabilizing element, and an electric resistance-increasing element: 1.0 mass % or more.

2. The raw material powder for soft magnetic powder according to 1., wherein the γ-phase stabilizing element is one or more selected from the group consisting of Ni, Mn, Cu, C, and N.

3. The raw material powder for soft magnetic powder according to 1. or 2., wherein the electric resistance-increasing element is one or more selected from the group consisting of Si, Al, and Cr.

4. The raw material powder for soft magnetic powder according to 1., wherein the γ-phase stabilizing element is Ni: 1.5 mass % to 20 mass %, and the electric resistance-increasing element is Si: 1.0 mass % to 6.5 mass %.

5. Soft magnetic powder for dust cores, comprising Fe: 60 mass % or more, a γ-phase stabilizing element, and an electric resistance-increasing element: 1.0 mass % or more, wherein a concentration of the electric resistance-increasing element in a center part of a particle constituting the soft magnetic powder for dust cores is 1.0 mass % or more, and the concentration of the electric resistance-increasing element in a surface layer of the particle constituting the soft magnetic powder for dust cores is higher than the concentration of the electric resistance-increasing element in the center part of the particle constituting the soft magnetic powder for dust cores.

### Advantageous Effect

It is thus possible to provide raw material powder that yields soft magnetic powder for dust cores having low eddy current loss, and the soft magnetic powder for dust cores.

### DETAILED DESCRIPTION

[Raw Material Powder for Soft Magnetic Powder]

One of the disclosed embodiments is described in detail below.

Raw material powder for soft magnetic powder in this embodiment contains Fe, a γ-phase stabilizing element, and an element for increasing electric resistance (hereafter “electric resistance-increasing element”), as essential components. Each of the components is described below.

[Fe]

The raw material powder for soft magnetic powder in this embodiment contains Fe as the principal component. The Fe content in the raw material powder for soft magnetic powder is 60 mass % or more. While there is no upper limit on the Fe content, the Fe content is preferably less than 98.5 mass % to sufficiently achieve the effects of the below-mentioned γ-phase stabilizing element and electric resistance-increasing element.

[γ-Phase Stabilizing Element]

Soft magnetic powder for dust cores in this embodiment can be manufactured by subjecting the raw material powder to the below-mentioned heat treatment so that the electric resistance-increasing element penetrates and diffuses into the surface layer of the particles constituting the powder. Here, if the crystal structure of the powder is the α (ferrite) phase, the electric resistance-increasing element ends up diffusing to the center part of the particles during the heat treatment because the electric resistance-increasing element easily diffuses in the α phase. This causes uniform concentration of the electric resistance-increasing element in the surface layer and the center part.

Hence, the γ-phase stabilizing element is added to stabilize the γ (austenite) phase during the heat treatment in this embodiment. The diffusion speed of Si in the γ phase is much lower than the diffusion speed of Si in the α phase, as mentioned above. Adding the γ-phase stabilizing element can therefore suppress the diffusion of Si from the particle surface layer to the center and effectively concentrate Si in the particle surface layer.

The γ-phase stabilizing element is an element in a binary phase diagram with Fe that, when added, decreases the α-γ transformation temperature. Examples of the γ-phase stabilizing element include Ni, Mn, Cu, C, and N. As the γ-phase stabilizing element, one element may be used, or two or more elements may be used in combination.

The content of the γ-phase stabilizing element in the raw material powder for soft magnetic powder is not limited, and may be any value. To enhance the γ-phase stabilizing effect, however, the total content of the γ-phase stabilizing element in the raw material powder for soft magnetic powder is preferably 0.5 mass % or more, and more preferably 1.0 mass % or more. Excessively adding the γ-phase stabilizing element can cause a decrease in saturation magnetic flux density of a dust core obtained using the powder. Accordingly, the total content of the γ-phase stabilizing element in the raw material powder for soft magnetic powder is preferably 39 mass % or less, and more preferably 30 mass % or less.

In the case of using Ni as the γ-phase stabilizing element, the Ni content is preferably 1.5 mass % or more and 20 mass % or less. When the Ni content is 1.5 mass % or more, the γ phase can be further stabilized. When the Ni content is 20 mass % or less, a decrease in saturation magnetic flux density can be further suppressed.

In the case of using Mn, Cu, C, and N as the γ-phase stabilizing element, the content of each element is preferably as follows:

Mn: 8.0 mass % or less (not including 0)

Cu: 4.0 mass % or less (not including 0)

C: 1.0 mass % or less (not including 0)

N: 2.4 mass % or less (not including 0).

The γ-phase stabilizing element such as Ni, Mn, Cu, C, and N may be used singly or in combination of two or more.

[Electric Resistance-Increasing Element]

The raw material powder for soft magnetic powder in this embodiment contains the electric resistance-increasing element in total amount of 1.0 mass % or more. By adding 1.0 mass % or more the electric resistance-increasing element, the electric resistance in the center part of the powder can be increased to reduce eddy current loss. To further reduce eddy current loss, the content of the electric resistance-increasing element is preferably 1.4 mass % or more. While there is no upper limit on the content of the electric resistance-increasing element, excessively adding the electric resistance-increasing element may cause an increase in hysteresis loss or a decrease in compressibility, and so the content of the electric resistance-increasing element is preferably 20.0 mass % or less.

The electric resistance-increasing element mentioned here is an element capable of forming a binary alloy with Fe, and is an element that, when added, has an effect of increasing the electric resistance of the binary alloy over Fe. Electric resistance is evaluated based on specific resistance. The method of evaluating specific resistance is, for example, four-terminal method.

The electric resistance-increasing element may be any element that meets the definition stated above. Examples of the electric resistance-increasing element include Si, Al, and Cr.

In the case of using Si, Al, and Cr as the electric resistance-increasing element, the content of each element is preferably as follows:

Si: 1.5 mass % to 6.5 mass %

Al: 1.0 mass % to 6.0 mass %

Cr: 1.0 mass % to 10.0 mass %.

The electric resistance-increasing element such as Si, Al, and Cr may be used singly or in combination of two or more.

The powder in this embodiment may optionally contain other components, in addition to Fe, the γ-phase stabilizing element, and the electric resistance-increasing element. To improve the properties of the soft magnetic powder, however, the powder is preferably composed of Fe, the γ-phase stabilizing element, the electric resistance-increasing element, and the balance that is incidental impurities. In such a case, the total content of the incidental impurities is preferably 1.0 mass % or less. Although the content of the incidental impurities is preferably as low as possible, the content of the incidental impurities may be more than 0 mass % from an industrial point of view. An element contained in the raw material powder as such incidental impurities is, for example, oxygen (O). To reduce hysteresis loss, the 0 content in the powder is preferably 0.3 mass % or less.

The apparent density of the raw material powder for soft magnetic powder is not limited, and may be any value. The apparent density is preferably 3.0 Mg/m³ or more, and more preferably 3.5 Mg/m³ or more. The apparent density of the raw material powder for soft magnetic powder obtained industrially is typically 5.0 Mg/m³ or less. The apparent density mentioned here is apparent density measured according to JIS Z 2504.

The specific surface area of the raw material powder for soft magnetic powder is not limited, and may be any value. The specific surface area is preferably 70 m²/kg or less in BET value. If the specific surface area is excessively large, contact between particles during forming caused by the indefinite shape is likely to increase inter-particle eddy current loss. While there is no lower limit on the specific surface area of the raw material powder, the specific surface area is preferably 10 m²/kg or more in BET value.

[Soft Magnetic Powder for Dust Cores]

Soft magnetic powder for dust cores in this embodiment contains 60 mass % or more Fe, the γ-phase stabilizing element, and 1.0 mass % or more the electric resistance-increasing element. The soft magnetic powder for dust cores may be the same as the raw material powder for soft magnetic powder described above, unless otherwise noted.

The concentration of the electric resistance-increasing element in the center part of the particles constituting the soft magnetic powder for dust cores is 1.0 mass % or more. This increases the electric resistance in the center part of the powder, thus reducing eddy current loss. To further reduce eddy current loss, the content of the electric resistance-increasing element in the center part is preferably 1.4 mass % or more. While there is no upper limit on the content of the electric resistance-increasing element, excessively adding the electric resistance-increasing element may cause an increase in hysteresis loss or a decrease in compressibility, and so the content of the electric resistance-increasing element in the center part is preferably 20.0 mass % or less.

Moreover, the concentration of the electric resistance-increasing element in the surface layer of the particles constituting the soft magnetic powder for dust cores is higher than the concentration of the electric resistance-increasing element in the center part of the particles constituting the soft magnetic powder for dust cores.

Intra-particle eddy current loss is loss due to eddy current flowing inside powder. In the case where the whole powder has uniform electric resistance, eddy current loss is greater in the powder surface layer where the path through which eddy current flows is longer.

By setting the concentration of the electric resistance-increasing element in the surface layer of the particles constituting the soft magnetic powder for dust cores to be higher than the concentration of the electric resistance-increasing element in the center part of the particles constituting the soft magnetic powder for dust cores as mentioned above, the electric resistance of the powder surface layer where the path through which eddy current flows is longer can be increased. By significantly reducing current in the powder surface layer having greater loss than the center part in this way, intra-particle eddy current loss can be reduced effectively.

To further enhance this effect, the difference in concentration of the electric resistance-increasing element between the surface layer and the center part is preferably 0.5 mass % or more, and more preferably 1.0 mass % or more. The difference in concentration of the electric resistance-increasing element between the surface layer and the center part is preferably 6.0 mass % or less from an industrial point of view.

The surface layer mentioned here is the region from the particle surface to the depth of 0.2 D, where D is the diameter of the cross section of the particle of the powder (equal to the particle size of the powder). The center part is the remainder of the particle other than the surface layer.

[Manufacturing Method]

The raw material powder for soft magnetic powder used in this embodiment can be manufactured by any method. Examples of the manufacturing method include an atomizing method, an oxide reduction method, and an electrolytic deposition method. The atomizing method is particularly preferable. Since powder manufactured by the atomizing method has a near-spherical particle shape, the use of powder (atomized powder) manufactured by the atomizing method can further suppress an increase in inter-particle eddy current loss caused by contact between particles in the dust core.

The atomizing method may be of any type, such as gas, water, gas and water, or centrifugation. In practical terms, however, it is preferable to use an inexpensive water atomizing method or a gas atomizing method, which is more expensive than a water atomizing method yet which is relatively suitable for mass production.

The following describes an example of the method of manufacturing the raw material powder for soft magnetic powder and the soft magnetic powder for dust cores in this embodiment using the water atomizing method.

First, molten steel containing the components described above is water atomized to obtain the raw material powder for soft magnetic powder.

Next, the electric resistance-increasing element is concentrated in the surface layer of the obtained raw material powder for soft magnetic powder, to manufacture the soft magnetic powder for dust cores. The method of concentrating the electric resistance-increasing element in the surface layer is not limited, and may be any method. Examples of the concentration method include the following:

(a) a method of depositing the element onto the surface of the powder by a CVD method or a PVD method to cause penetration and diffusion;

(b) a method of coating the surface of the powder with the element and then performing heat treatment to cause penetration and diffusion;

(c) a method of reducing the oxide of the element, which is present in the surface layer of the powder or in contact with the powder, by C contained in the powder to cause penetration and diffusion by solid-phase diffusion; and

(d) a method of dipping the powder into a melt to cause penetration and diffusion by liquid-phase diffusion.

A CVD method using SiCl₄ gas, which is one of the concentration methods, is described below.

The CVD method using SiCl₄ gas is a method of exposing the powder to a high-temperature SiCl₄ gas atmosphere to cause Si in SiCl₄ to penetrate and diffuse into the powder. The remaining 4Cl reacts with iron to form FeCl₄, and is discharged from the system

To cause such reaction, heat treatment is preferably performed while supplying SiCl₄ gas of 0.01 NL/min/kg to 50 NL/min/kg at 800° C. or more. If the heat treatment temperature is less than 800° C., Cl generated during the heat treatment may remain in the soft magnetic powder and cause an increase in hysteresis loss. Even when the heat treatment temperature is 800° C. or more, if the crystal structure of the soft magnetic powder during the heat treatment becomes the α phase, Si diffuses to the center, which is not preferable. Accordingly, the heat treatment is preferably performed in such a temperature range where the soft magnetic powder is in the γ phase. For example, in the case where the powder is composed of Si: 1.5 mass %, Ni: 1.5 mass %, and Fe, the heat treatment is preferably performed at 1050° C. or more. If the heat treatment temperature is more than 1400° C., the sintering of the powder progresses during the heat treatment, which may make grinding difficult. The heat treatment temperature is therefore preferably 1400° C. or less. The heat treatment time differs depending on the temperature, but typically the heat treatment is preferably performed for 10 min to 5 hr.

The components of the soft magnetic powder for dust cores obtained in this way are unchanged from those of the raw material powder before the concentration, except Si. Even regarding Si, it increases by only about 0.2 mass % at the maximum. Hence, the Si content in the soft magnetic powder for dust cores is preferably 1.0 mass % to 6.7 mass %. In the case of using Al as the electric resistance-increasing element, the Al content in the soft magnetic powder for dust cores is preferably 1.0 mass % to 6.2 mass %. In the case of using Cr as the electric resistance-increasing element, the Cr content is preferably 1.0 mass % to 10.2 mass %.

The soft magnetic powder for dust cores tends to have slightly lower apparent density and larger specific surface area (BET value) than the raw material powder, although depending on the heat treatment conditions.

Eddy current loss occurs due to current flowing inside particles, as mentioned earlier. Accordingly, eddy current loss can be reduced by reducing the particle size of the soft magnetic powder for dust cores. The mass average particle size D₅₀ of the soft magnetic powder for dust cores is therefore preferably 80 μm or less, and more preferably 70 μm or less. Excessively reducing the particle size, however, causes an increase in hysteresis loss or a decrease in yield rate, so that typically D₅₀ is preferably 20 μm or more.

A dust core can be manufactured by applying an insulating coating to the soft magnetic powder for dust cores and then forming the soft magnetic powder. The insulating coating may be of any material capable of maintaining insulation between particles. Examples of the material of the insulating coating include: silicone resin; a vitreous insulating amorphous layer with metal phosphate or metal borate as a base; a metal oxide such as MgO, forsterite, talc, or Al₂O₃; and a crystalline insulating layer with SiO₂ as a base.

When pressure forming the powder, a lubricant may be optionally applied to the die walls or added to the powder. The use of the lubricant can reduce the friction between the die and the powder during the pressure formation, thus suppressing a decrease in green density. Moreover, the friction upon removal from the die can also be reduced, effectively preventing cracks in the green compact (dust core) upon removal from the die. Preferable lubricants include metallic soaps such as lithium stearate, zinc stearate, and calcium stearate, and waxes such as fatty acid amide.

After performing the pressure formation to obtain the dust core as described above, the dust core is preferably heat treated. The heat treatment can remove strain, and as a result reduce hysteresis loss and increase the green compact strength. The soaking temperature of the heat treatment is preferably 500° C. to 800° C. The heat treatment time is preferably 5 min to 120 min. The heat treatment may be performed in any atmosphere such as air, an inert atmosphere, a reducing atmosphere, or a vacuum. The atmospheric dew point may be determined appropriately according to use. Furthermore, when raising or lowering the temperature during the heat treatment, a stage at which the temperature is maintained constant may be provided. Methods and conditions for obtaining the dust core other than those described above may be any methods and conditions such as well-known ones.

### Examples

Raw material powders of 14 types of compositions of material IDs: 1, 2-1 to 2-4, and 3 to 11 were used. Table 1 lists the elements added to each raw material powder, the apparent density of the raw material powder, etc. Every raw material powder had a chemical composition containing the elements shown in Table 1 and the balance being Fe and incidental impurities.

Of these raw material powders, the powders of material IDs: 1, 2-1 to 2-4, and 3 to 9 were subjected to Si penetration and diffusion treatment by a CVD method using SiCl₄. Table 2 lists the conditions of the penetration and diffusion treatment. The powders of material IDs: 1 and 2-1 were heat treated under three conditions A, B, and C, and the other powders were heat treated under one condition B.

Each powder subjected to the penetration and diffusion treatment was embedded in thermoplastic resin, and then subjected to cross section polishing. Powder having a diameter of about 100 μm in the cross section was selected, and line mapping by an electron probe micro-analyser (EPMA) was conducted so as to cross the center of the cross section of the powder.

TABLE 1

| | | | | | Specific |
|---|---|---|---|---|---|
| | | | | Apparent | surface |
| | Si | Ni | Mn | density | area |
| Material ID | (mass %) | (mass %) | (mass %) | (Mg/m³) | (m²/kg) |
| 1 | 1.5 | 0 | 0 | 4.3 | 40 |
| 2-1 | 1.5 | 1.5 | 0 | 4.3 | 40 |
| 2-2 | 1.5 | 1.5 | 0 | 3.6 | 52 |
| 2-3 | 1.5 | 1.5 | 0 | 3.1 | 66 |
| 2-4 | 1.5 | 1.5 | 0 | 2.9 | 73 |
| 3 | 1.5 | 2 | 0 | 4.4 | 38 |
| 4 | 1.5 | 10 | 0 | 4.3 | 40 |
| 5 | 1.5 | 15 | 0 | 4.3 | 40 |
| 6 | 1.5 | 20 | 0 | 4.2 | 41 |
| 7 | 1.5 | 0 | 3 | 4.2 | 41 |
| 8 | 1.5 | 0 | 6 | 4.1 | 43 |
| 9 | 0 | 0 | 0 | 4.1 | 43 |
| 10 | 3 | 0 | 0 | 4.1 | 43 |
| 11 | 0 | 0 | 0 | 4.1 | 43 |

TABLE 2

| | Soaking temperature | Soaking time |
|---|---|---|
| Heat treatment condition | (° C.) | (min) |
| A | 1050 | 360 |
| B | 1150 | 180 |
| C | 1420 | 180 |

After this, the average Si concentration from the particle surface to the depth of 0.2 D and the average Si concentration of the center part of the powder were calculated. Table 3 lists the calculation results together with the heat treatment conditions and the like.

TABLE 3

| | | | Si concentration | | | | | |
|---|---|---|---|---|---|---|---|---|
| | | | (mass %) | | | | | |
| Test | Material | Heat treatment | Center | Surface | Difference between center part | Specific surface area | Apparent density | |
| No. | ID | condition | part | layer | and surface layer | (m²/kg) | (Mg/m³) | Remarks |
| 1 | 1 | A | 2.5 | 2.5 | 0 | 40 | 4.3 | Comparative Example |
| 2 | 2-1 | A | 1.7 | 3.0 | 1.3 | 40 | 4.3 | Example |
| 3 | 1 | B | 2.5 | 2.5 | 0 | 40 | 4.1 | Comparative Example |
| 4 | 2-1 | B | 1.8 | 3.0 | 1.2 | 40 | 4.2 | Example |
| 5 | 2-2 | B | 1.9 | 3.0 | 1.1 | 52 | 3.5 | Example |
| 6 | 2-3 | B | 2.0 | 3.0 | 1.0 | 66 | 3.0 | Example |
| 7 | 2-4 | B | 2.4 | 3.0 | 0.6 | 73 | 2.8 | Example |
| 8 | 3 | B | 1.7 | 3.0 | 1.3 | 38 | 4.3 | Example |
| 9 | 4 | B | 1.6 | 3.2 | 1.6 | 40 | 4.2 | Example |
| 10 | 5 | B | 1.5 | 3.2 | 1.7 | 40 | 4.2 | Example |
| 11 | 6 | B | 1.5 | 3.5 | 2.0 | 41 | 4.2 | Example |
| 12 | 7 | B | 2.0 | 2.7 | 0.7 | 41 | 4.0 | Example |
| 13 | 8 | B | 1.8 | 2.7 | 0.9 | 43 | 3.9 | Example |
| 14 | 9 | B | 0.0 | 1.1 | 1.1 | 43 | 4.0 | Comparative Example |

| | | | | |
|---|---|---|---|---|
| 15 | 1 | C | Not evaluated because sintering progressed | Comparative Example |
| 16 | 2-1 | C | and crushing was difficult. | Comparative Example |
| 17 | 2-2 | C | | Comparative Example |
| 18 | 2-3 | C | | Comparative Example |
| 19 | 2-4 | C | | Comparative Example |
| 20 | 3 | C | | Comparative Example |
| 21 | 4 | C | | Comparative Example |
| 22 | 5 | C | | Comparative Example |
| 23 | 6 | C | | Comparative Example |
| 24 | 7 | C | | Comparative Example |
| 25 | 8 | C | | Comparative Example |
| 26 | 9 | C | | Comparative Example |

For all samples (test Nos. 15 to 26) subjected to heat treatment under heat treatment condition C, sintering progressed and crushing was difficult, and so the Si concentration was not measured. Of the samples subjected to heat treatment under heat treatment conditions A and B, test Nos. 1 and 3 did not contain the γ-phase stabilizing element, and therefore the difference (Si concentration difference) between the surface layer Si concentration and the center part Si concentration was 0 mass %. The other samples had a Si concentration difference of 0.5 mass % or more.

Each obtained powder was sieved (according to JIS Z 2510). In Table 3, the iron powder of test No. 2 was sieved to 80 μm, 70 μm, 60 μm, and 20 μm in average particle size D₅₀, and the other iron powders were sieved to 80 μm in average particle size D₅₀. An insulating coating was then applied to each of these powders using silicone resin. The coating of the silicone resin was formed as follows. First, the silicone resin was dissolved in toluene to produce a resin dilute solution having a silicone resin concentration of 1.0 mass %. Next, the powder and the resin dilute solution were mixed so that the rate of addition of the resin with respect to the powder was 0.5 mass %. After this, the result was dried in the air, and then subjected to a resin baking process in the air at 200° C. for 120 min to yield coated iron powder.

The obtained coated iron powder was then formed using a die lubrication forming method at a compacting pressure of 15 t/cm² (1.47 GN/m²), to produce a ring-shaped test piece with an outer diameter of 38 mm, an inner diameter of 25 mm, and a height of 6 mm.

Each test piece produced by such a procedure was subjected to heat treatment in nitrogen at 750° C. for 30 min to yield a dust core. Winding was then performed (primary winding: 100 turns; secondary winding: 40 turns), and hysteresis loss measurement (0.2 T) with a DC magnetizing device (DC magnetizing measurement device produced by METRON, Inc.) and iron loss measurement (0.2 T, 20 kHz) with an iron loss measurement device (high-frequency iron loss measurement device produced by METRON, Inc.) were performed. Eddy current loss was calculated from the difference between the obtained iron loss and hysteresis loss. Table 4 lists the eddy current loss measurement results.

TABLE 4

| | | | Eddy | | |
|---|---|---|---|---|---|
| | | Heat | current | Particle | |
| Test | Material | treatment | loss | size D₅₀ | |
| No. | ID | condition | (kW/m³) | (μm) | Remarks |
| 1 | 1 | A | 750 | 80 | Comparative Example |
| 2-1 | 2-1 | A | 324 | 80 | Example |
| 2-2 | 2-1 | A | 248 | 70 | Example |
| 2-3 | 2-1 | A | 182 | 60 | Example |
| 2-4 | 2-1 | A | 20 | 20 | Example |
| 3 | 1 | B | 740 | 80 | Comparative Example |
| 4 | 2-1 | B | 350 | 80 | Example |
| 5 | 2-2 | B | 390 | 80 | Example |
| 6 | 2-3 | B | 400 | 80 | Example |
| 7 | 2-4 | B | 500 | 80 | Example |
| 8 | 3 | B | 360 | 80 | Example |
| 9 | 4 | B | 330 | 80 | Example |
| 10 | 5 | B | 324 | 80 | Example |
| 11 | 6 | B | 300 | 80 | Example |
| 12 | 7 | B | 470 | 80 | Example |
| 13 | 8 | B | 430 | 80 | Example |
| 14 | 9 | B | 650 | 80 | Comparative Example |
| 27 | 10 | — | 700 | 80 | Comparative Example |
| 28 | 11 | — | 1000 | 80 | Comparative Example |

As shown in Table 4, for both of the dust cores of test Nos. 1 and 3 having a difference (Si concentration difference) between the surface layer Si concentration and the center part Si concentration of 0 mass %, eddy current loss was more than 700 kW/m³, which is higher than that of the Fe-3 mass % Si dust core of test No. 27.

For the dust core of test No. 14 with Si penetration and diffusion treatment performed on pure iron powder, the Si concentration difference was 0.5 mass % or more, but the center part Si concentration was less than 1.0 mass %, so that eddy current loss was 650 kW/m³.

For each dust core (test Nos. 2-1 to 2-4, 4 to 13) having a center part Si concentration of 1.0 mass % or more and a Si concentration difference of 0.5 mass % or more, eddy current loss was 500 kW/m³ or less, which is at least 200 kW/m³ lower than that of the Fe-3 mass % Si dust core of test No. 27. For each dust core (test Nos. 2-1 to 2-4, 4 to 6, 8 to 11) having a Si concentration difference of 1.0 mass % or more, eddy current loss was very low, i.e. 400 kW/m³ or less. For each dust core (test Nos. 2-1 to 2-4) made of powder with different D₅₀, iron loss was lower when the particle size was smaller.

1. Raw material powder for soft magnetic powder, comprising
Fe: 60 mass % or more,
a γ-phase stabilizing element, and
an electric resistance-increasing element: 1.0 mass % or more.

2. The raw material powder for soft magnetic powder according to claim 1,
wherein the γ-phase stabilizing element is one or more selected from the group consisting of Ni, Mn, Cu, C, and N.

3. The raw material powder for soft magnetic powder according to claim 1,
wherein the electric resistance-increasing element is one or more selected from the group consisting of Si, Al, and Cr.

4. The raw material powder for soft magnetic powder according to claim 1,
wherein the γ-phase stabilizing element is Ni: 1.5 mass % to 20 mass %, and
the electric resistance-increasing element is Si: 1.0 mass % to 6.5 mass %.

5. Soft magnetic powder for dust cores, comprising
Fe: 60 mass % or more,
a γ-phase stabilizing element, and
an electric resistance-increasing element: 1.0 mass % or more,
wherein a concentration of the electric resistance-increasing element in a center part of a particle constituting the soft magnetic powder for dust cores is 1.0 mass % or more, and
the concentration of the electric resistance-increasing element in a surface layer of the particle constituting the soft magnetic powder for dust cores is higher than the concentration of the electric resistance-increasing element in the center part of the particle constituting the soft magnetic powder for dust cores.

6. The raw material powder for soft magnetic powder according to claim 2,
wherein the electric resistance-increasing element is one or more selected from the group consisting of Si, Al, and Cr.
